(19) United States
(12) Patent Application Publication
(10) Pub. No.: US 2009/0046105 A1
(43) Pub. Date: Feb. 19, 2009

(54) Conditional execute bit in a graphics processor unit pipeline

(76) Inventors: Tyson J. Bergland, Palo Alto, CA (US); Craig M. Okruhlica, San Jose, CA (US)

Correspondence Address: NVIDIA C/O MURABITO, HAO & BARNES LLP, TWO NORTH MARKET STREET, THIRD FLOOR, SAN JOSE, CA, 95113, US

(21) Appl. No.: 11/893,620

(22) Filed: Aug. 15, 2007

(51) Int. Cl. G09G 5/00

(52) U.S. Cl. 345/581

(57) ABSTRACT

An arithmetic logic stage in a graphics processor unit includes a number of arithmetic logic units (ALUs). An instruction is applied to sets of operands comprising pixel data associated with different pixels. The value of a conditional execute bit determines how the pixel data in a set of operands is processed by the ALUs.

### RELATED U.S. APPLICATIONS

This application is related to U.S. patent application Ser. No. ______ by T. Bergland et al., filed on ______, entitled “Buffering Deserialized Pixel Data in a Graphics Processor Unit Pipeline,” with Attorney Docket No. NVID-P003219, assigned to the assignee of the present invention, and hereby incorporated by reference in its entirety.

This application is related to U.S. patent application Ser. No. ______ by T. Bergland et al., filed on ______, entitled “Shared Readable and Writeable Global Values in a Graphics Processor Unit Pipeline,” with Attorney Docket No. NVID-P003476, assigned to the assignee of the present invention, and hereby incorporated by reference in its entirety.

### FIELD

Embodiments of the present invention generally relate to computer graphics.

### BACKGROUND

Recent advances in computer performance have enabled graphics systems to provide more realistic graphical images using personal computers, home video game computers, handheld devices, and the like. In such graphics systems, a number of procedures are executed to render or draw graphics primitives to the screen of the system. A graphics primitive is a basic component of a graphic, such as a point, line, polygon, or the like. Rendered images are formed with combinations of these graphics primitives. Many procedures may be utilized to perform three-dimensional (3-D) graphics rendering.

Specialized graphics processing units (GPUs) have been developed to increase the speed at which graphics rendering procedures are executed. The GPUs typically incorporate one or more rendering pipelines. Each pipeline includes a number of hardware-based functional units that are designed for high-speed execution of graphics instructions/data. Generally, the instructions/data are fed into the front end of a pipeline and the computed results emerge at the back end of a pipeline. The hardware-based functional units, cache memories, firmware, and the like, of the GPUs are designed to operate on the basic graphics primitives and produce real-time rendered 3-D images.

There is increasing interest in rendering 3-D graphical images in portable or handheld devices such as cell phones, personal digital assistants (PDAs), and other devices. However, portable or handheld devices generally have limitations relative to more full-sized devices such as desktop computers. For example, because portable devices are typically battery-powered, power consumption is a concern. Also, because of their smaller size, the space available inside portable devices is limited. The desire is to quickly perform realistic 3-D graphics rendering in a handheld device, within the limitations of such devices.

### SUMMARY

Embodiments of the present invention provide methods and systems for quickly and efficiently processing data in a graphics processor unit pipeline.

Pixel data for a group of pixels proceeds collectively down the graphics pipeline to the arithmetic logic units (ALUs). In the ALUs, a same instruction is applied to all pixels in a group in SIMD (single instruction, multiple data) fashion. For example, in a given clock cycle, an instruction will specify a set of operands that are selected from the pixel data for a first pixel in the group of pixels. In the next clock cycle, the instruction will specify another set of operands that are selected from the pixel data for a second pixel in the group, and so on. According to embodiments of the present invention, a conditional execute bit is associated with each set of operands. The values of the conditional execute bits determine how (whether) the respective sets of operands are processed by the ALUs.

In general, if a conditional execute bit is set to do not execute, then the pixel data associated with that conditional execute bit is not operated on by the ALUs. More specifically, in one embodiment, the pixel data is not latched by the ALUs if the conditional execute bit is set to do not execute; this can be accomplished by gating the input flip-flops to the ALUs so that the flip-flops do not clock in the pixel data. Accordingly, the ALUs do not change state—the latches (flip-flops) in the ALUs remain in the state they were in on the previous clock cycle. Power is saved by not clocking the flip-flops, and power is also saved because the inputs to the combinational logic remain the same and therefore no transistors change state (the flip-flops do not transition from one state to another because, if the conditional bit is set to do not execute, then the operands remain the same from one clock cycle to the next).

In summary, an instruction is applied across a group of pixels, but it may not be necessary to execute the instruction on each pixel in the group. To maintain proper order in the pipeline, the instruction is applied to each pixel in the group—a set of operands is selected for each pixel in the group. However, if a conditional execute bit associated with a set of operands is set to do not execute, then those operands are not operated on by the ALUs—the associated instruction is not executed on the operands and instead the downstream operands are replicated. Consequently, flip-flops are not unnecessarily clocked and combinational logic is not unnecessarily switched, thereby saving power. As such, embodiments of the present invention are well-suited for graphics processing in handheld and other portable, battery-operated devices (although the present invention is not limited to use on those types of devices).

These and other objects and advantages of the various embodiments of the present invention will be recognized by those of ordinary skill in the art after reading the following detailed description of the embodiments that are illustrated in the various drawing figures.

### BRIEF DESCRIPTION OF THE DRAWINGS

The present invention is illustrated by way of example, and not by way of limitation, in the figures of the accompanying drawings and in which like reference numerals refer to similar elements.

FIG. 1 is a block diagram showing components of a computer system in accordance with one embodiment of the present invention.

FIG. 2 is a block diagram showing components of a graphics processing unit (GPU) in accordance with one embodiment of the present invention.

FIG. 3 illustrates stages in a GPU pipeline according to one embodiment of the present invention.

FIG. 4 illustrates a series of rows of pixel data according to an embodiment of the present invention.

FIG. 5 is a block diagram of an arithmetic logic stage in a GPU according to one embodiment of the present invention.

FIG. 6 illustrates pixel data exiting an arithmetic logic unit according to an embodiment of the present invention.

FIG. 7A illustrates pixel data in various stages of an ALU according to one embodiment of the present invention.

FIG. 7B illustrates the various stages of an ALU according to an embodiment of the present invention.

FIG. 8 is a flowchart of a computer-implemented method for processing pixel data according to one embodiment of the present invention.

### DETAILED DESCRIPTION

Reference will now be made in detail to embodiments of the present invention, examples of which are illustrated in the accompanying drawings. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of embodiments of the present invention, numerous specific details are set forth in order to provide a thorough understanding of the present invention. However, it will be recognized by one of ordinary skill in the art that the present invention may be practiced without these specific details. In other instances, well-known methods, procedures, components, and circuits have not been described in detail as not to unnecessarily obscure aspects of the embodiments of the present invention.

Some portions of the detailed descriptions, which follow, are presented in terms of procedures, steps, logic blocks, processing, and other symbolic representations of operations on data bits within a computer memory. These descriptions and representations are the means used by those skilled in the data processing arts to most effectively convey the substance of their work to others skilled in the art. A procedure, computer executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

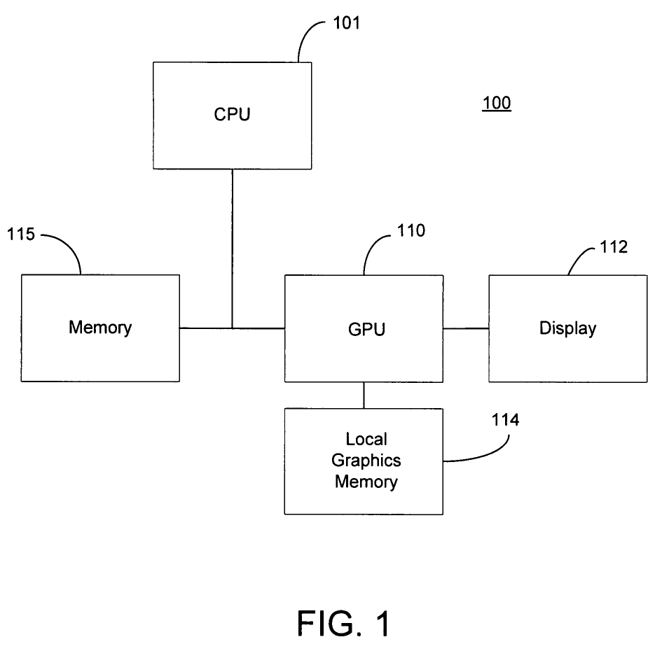

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “determining” or “using” or “setting” or “latching” or “clocking” or “identifying” or “selecting” or “processing” or “controlling” or the like, refer to the actions and processes of a computer system (e.g., computer system 100 of FIG. 1), or similar electronic computing device, that manipulates and transforms data represented as physical (electronic) quantities within the computer system's registers and memories into other data similarly represented as physical quantities within the computer system memories or registers or other such information storage, transmission or display devices.

FIG. 1 shows a computer system 100 in accordance with one embodiment of the present invention. The computer system includes the components of a basic computer system in accordance with embodiments of the present invention providing the execution platform for certain hardware-based and software-based functionality. In general, the computer system comprises at least one central processing unit (CPU) 101, a system memory 115, and at least one graphics processor unit (GPU) 110. The CPU can be coupled to the system memory via a bridge component/memory controller (not shown) or can be directly coupled to the system memory via a memory controller (not shown) internal to the CPU. The GPU is coupled to a display 112. One or more additional GPUs can optionally be coupled to system 100 to further increase its computational power. The GPU(s) is/are coupled to the CPU and the system memory. The computer system can be implemented as, for example, a desktop computer system or server computer system, having a powerful general-purpose CPU coupled to a dedicated graphics rendering GPU. In such an embodiment, components can be included that add peripheral buses, specialized graphics memory, input/output (I/O) devices, and the like. Similarly, computer system can be implemented as a handheld device (e.g., a cell phone, etc.) or a set-top video game console device.

The GPU can be implemented as a discrete component, a discrete graphics card designed to couple to the computer system via a connector (e.g., an Accelerated Graphics Port slot, a Peripheral Component Interconnect-Express slot, etc.), a discrete integrated circuit die (e.g., mounted directly on a motherboard), or an integrated GPU included within the integrated circuit die of a computer system chipset component (not shown) or within the integrated circuit die of a PSOC (programmable system-on-a-chip). Additionally, a local graphics memory 114 can be included for the GPU for high bandwidth graphics data storage.

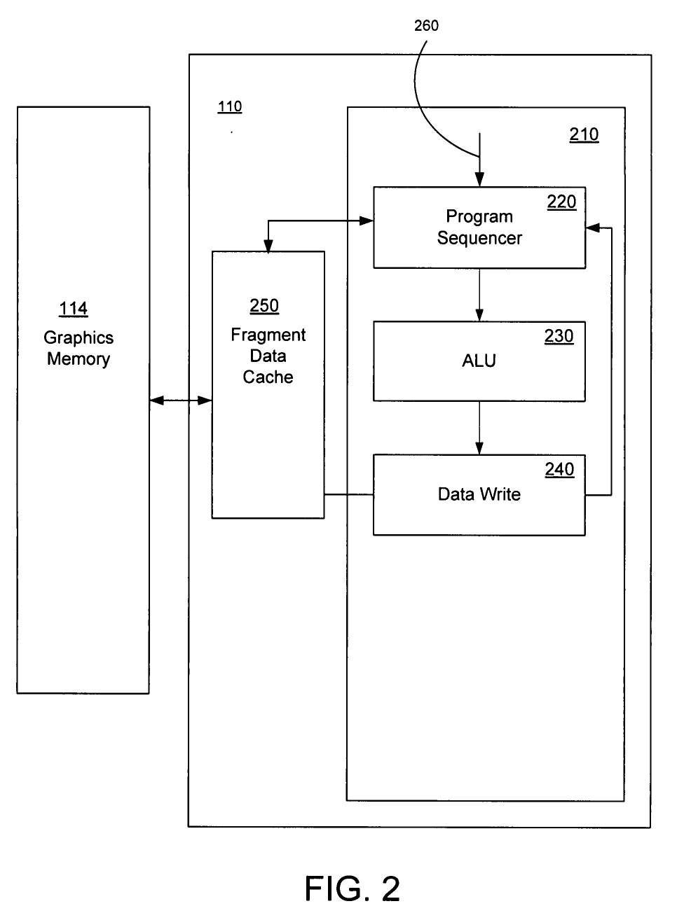

FIG. 2 shows a diagram illustrating internal components of the GPU 110 and the graphics memory 114 in accordance with one embodiment of the present invention. As depicted in FIG. 2, the GPU includes a graphics pipeline 210 and a fragment data cache 250 which couples to the graphics memory as shown.

In the example of FIG. 2, a graphics pipeline 210 includes a number of functional modules. Three such functional modules of the graphics pipeline—for example, the program sequencer 220, the arithmetic logic stage (ALU) 230, and the data write component 240—function by rendering graphics primitives that are received from a graphics application (e.g., from a graphics driver, etc.). The functional modules 220-240 access information for rendering the pixels related to the graphics primitives via the fragment data cache 250. The fragment data cache functions as a high-speed cache for the information stored in the graphics memory (e.g., frame buffer memory).

The program sequencer functions by controlling the operation of the functional modules of the graphics pipeline. The program sequencer can interact with the graphics driver (e.g., a graphics driver executing on the CPU 101 of FIG. 1) to control the manner in which the functional modules of the graphics pipeline receive information, configure themselves for operation, and process graphics primitives. For example, in the FIG. 2 embodiment, graphics rendering data (e.g., primitives, triangle strips, etc.), pipeline configuration information (e.g., mode settings, rendering profiles, etc.), and rendering programs (e.g., pixel shader programs, vertex shader programs, etc.) are received by the graphics pipeline over a common input 260 from an upstream functional module (e.g., from an upstream raster module, from a setup module, or from the graphics driver). The input 260 functions as the main fragment data pathway, or pipeline, between the functional modules of the graphics pipeline. Primitives are generally received at the front end of the pipeline and are progressively rendered into resulting rendered pixel data as they proceed from one module to the next along the pipeline.

In one embodiment, data proceeds between the functional modules 220-240 in a packet-based format. For example, the graphics driver transmits data to the GPU in the form of data packets, or pixel packets, that are specifically configured to interface with and be transmitted along the fragment pipe communications pathways of the pipeline. A pixel packet generally includes information regarding a group or tile of pixels (e.g., four pixels, eight pixels, 16 pixels, etc.) and coverage information for one or more primitives that relate to the pixels. A pixel packet can also include sideband information that enables the functional modules of the pipeline to configure themselves for rendering operations. For example, a pixel packet can include configuration bits, instructions, functional module addresses, etc., that can be used by one or more of the functional modules of the pipeline to configure itself for the current rendering mode, or the like. In addition to pixel rendering information and functional module configuration information, pixel packets can include shader program instructions that program the functional modules of the pipeline to execute shader processing on the pixels. For example, the instructions comprising a shader program can be transmitted down the graphics pipeline and be loaded by one or more designated functional modules. Once loaded, during rendering operations, the functional module can execute the shader program on the pixel data to achieve the desired rendering effect.

In this manner, the highly optimized and efficient fragment pipe communications pathway implemented by the functional modules of the graphics pipeline can be used not only to transmit pixel data between the functional modules (e.g., modules 220-240), but to also transmit configuration information and shader program instructions between the functional modules.

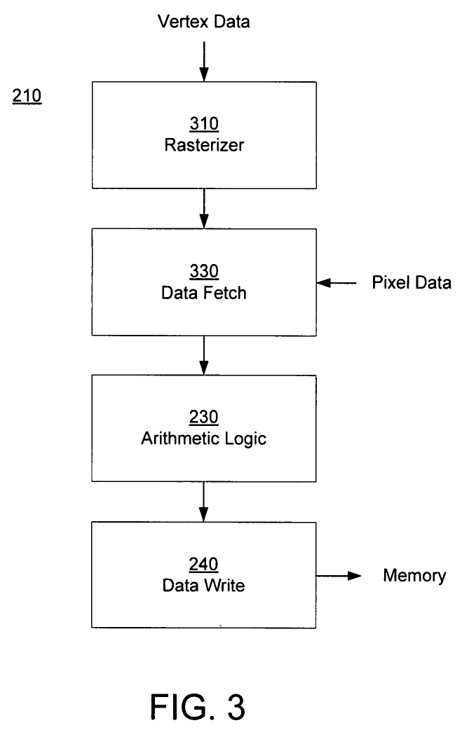

FIG. 3 is a block diagram showing selected stages in a graphics pipeline 210 according to one embodiment of the present invention. A graphics pipeline may include additional stages or it may be arranged differently than the example of FIG. 3. In other words, although the present invention is discussed in the context of the pipeline of FIG. 3, the present invention is not so limited.

In the example of FIG. 3, the rasterizer 310 translates triangles to pixels using interpolation. Among its various functions, the rasterizer receives vertex data, determines which pixels correspond to which triangle, and determines shader processing operations that need to be performed on a pixel as part of the rendering, such as color, texture, and fog operations.

The rasterizer generates a pixel packet for each pixel of a triangle that is to be processed. A pixel packet is, in general, a set of descriptions used for calculating an instance of a pixel value for a pixel in a frame of a graphical display. A pixel packet is associated with each pixel in each frame. Each pixel is associated with a particular (x,y) location in screen coordinates. In one embodiment, the graphics system renders a two pixel-by-two pixel region of a display screen, referred to as a quad.

Each pixel packet includes a payload of pixel attributes required for processing (e.g., color, texture, depth, fog, x and y locations, etc.) and sideband information (pixel attribute data is provided by the data fetch stage 330). A pixel packet may contain one row of data or it may contain multiple rows of data. A row is generally the width of the data portion of the pipeline bus.

The data fetch stage fetches data for pixel packets. Such data may include color information, any depth information, and any texture information for each pixel packet. Fetched data is placed into an appropriate field, which may be referred to herein as a register, in a row of pixel data prior to sending the pixel packet on to the next stage.

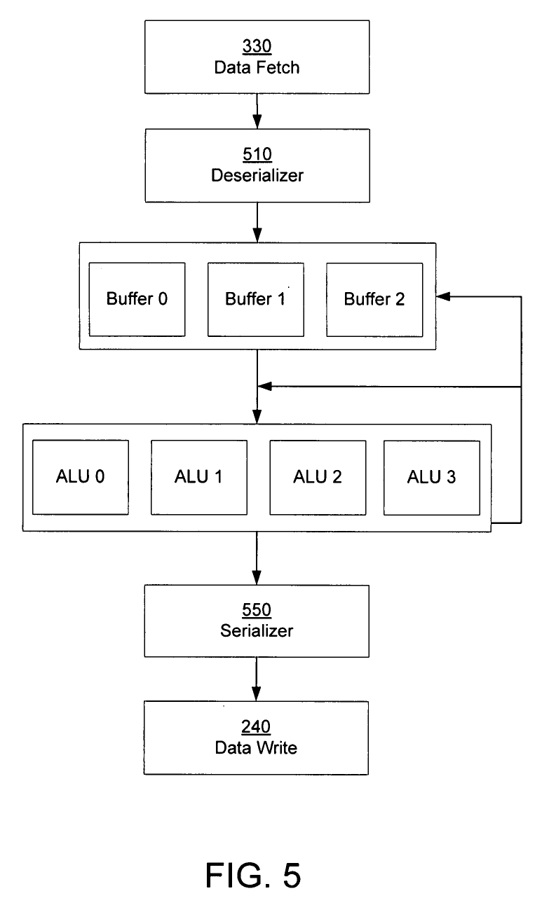

From the data fetch stage, rows of pixel data enter the arithmetic logic stage 230. In the present embodiment, one row of pixel data enters the arithmetic logic stage each clock cycle. In one embodiment, the arithmetic logic stage includes four ALUs 0, 1, 2 and 3 (FIG. 5) configured to execute a shader program related to three-dimensional graphics operations such as, but not limited to, texture combine (texture environment), stencil, fog, alpha blend, alpha test, and depth test. Each ALU executes an instruction per clock cycle, each instruction for performing an arithmetic operation on operands that correspond to the contents of the pixel packets. In one embodiment, it takes four clock cycles for a row of data to be operated on in an ALU—each ALU has a depth of four cycles.

The output of the arithmetic logic stage goes to the data write stage. The data write stage stores pipeline results in a write buffer or in a framebuffer in memory (e.g., graphics memory 114 or memory 115 of FIGS. 1 and 2). Optionally, pixel packets/data can be recirculated from the data write stage back to the arithmetic logic stage if further processing of the data is needed.

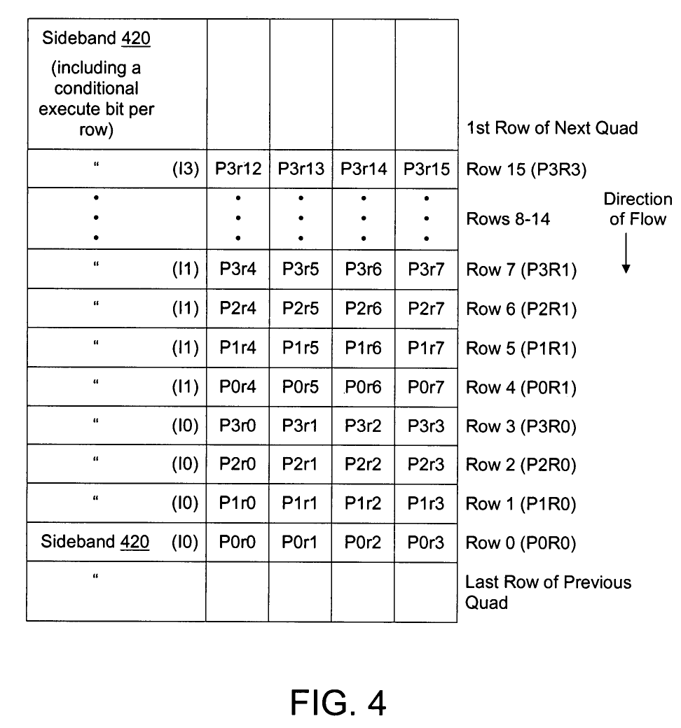

FIG. 4 illustrates a succession of pixel data—that is, a series of rows of pixel data—for a group of pixels according to an embodiment of the present invention. In the example of FIG. 4, the group of pixels comprises a quad of four pixels: P0, P1, P2 and P3. As mentioned above, the pixel data for a pixel can be separated into subsets or rows of data. In one embodiment, there may be up to four rows of data per pixel. For example, row 0 includes four fields or registers of pixel data P0r0, P0r1, P0r2 and P0r3 (“r” designates a field or register in a row, and “R” designates a row). Each of the rows may represent one or more attributes of the pixel data. These attributes include, but are not limited to, z-depth values, texture coordinates, level of detail, color, and alpha. The register values can be used as operands in operations executed by the ALUs in the arithmetic logic stage.

Sideband information 420 is associated with each row of pixel data. The sideband information includes, among other things, information that identifies or points to an instruction that is to be executed by an ALU using the pixel data identified by the instruction. In other words, the sideband information associated with row 0 identifies, among other things, an instruction I0. An instruction can specify, for example, the type of arithmetic operation to be performed and which registers contain the data that is to be used as operands in the operation.

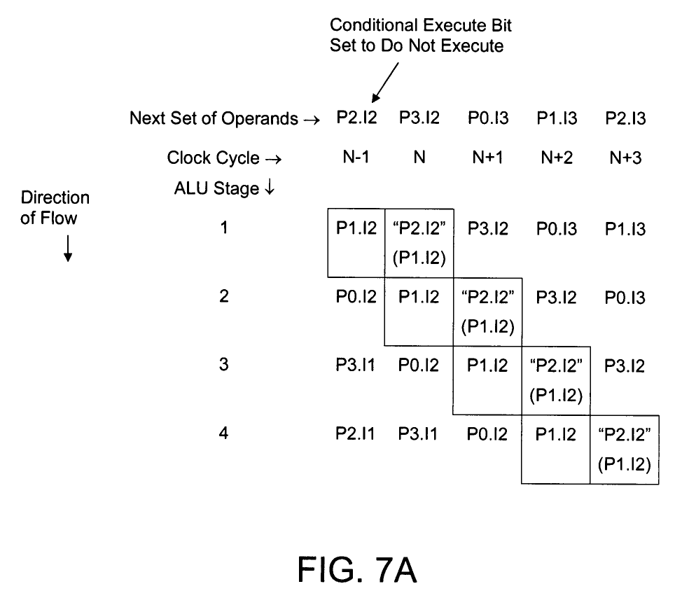

In one embodiment, the sideband information includes a conditional execute bit per row of pixel data. The value of the conditional execute bit may be different for each row of pixel data, even if the rows are associated with the same pixel. A conditional execute bit associated with a row of pixel data can be set in order to prevent execution of an instruction on operands of the associated pixel. For example, if the conditional execute bit associated with P0R0 is set to do not execute, then instruction I0 will not be executed for pixel P0 (but can still be executed for the other pixels in the group). The function of the conditional execute bit is described further below, in conjunction with FIG. 7A. In one embodiment, the conditional execute bit is a single bit in length.

FIG. 5 is a block diagram of the arithmetic logic stage 230 according to one embodiment of the present invention. Only certain elements are shown in FIG. 5; the arithmetic logic stage may include elements in addition to those shown in FIG. 5 and described below.

With each new clock cycle, a row of pixel data proceeds in succession from the data fetch stage to the arithmetic logic stage of the pipeline. For example, row 0 proceeds down the pipeline on a first clock, followed by row 1 on the next clock, and so on. Once all of the rows associated with a particular group of pixels (e.g., a quad) are loaded into the pipeline, rows associated with the next quad can begin to be loaded into the pipeline.

In one embodiment, rows of pixel data for each pixel in a group of pixels (e.g., a quad) are interleaved with rows of pixel data for the other pixels in the group. For example, for a group of four pixels, with four rows per pixel, the pixel data proceeds down the pipeline in the following order: the first row for the first pixel (P0r0 through P0r3), the first row for the second pixel (P1r0 through P1r3), the first row for the third pixel (P2r0 through P2r3), the first row for the fourth pixel (P3r0 through P3r3), the second row for the first pixel (P0r4 through P0r7), the second row for the second pixel (P1r4 through P1r7), the second row for the third pixel (P2r4 through P2r7), the second row for the fourth pixel (P3r4 through P3r7), and so on to the fifteenth row, which includes P3r12 through P3r15. As mentioned above, there may be less than four rows per pixel. By interleaving rows of pixel packets in this fashion, stalls in the pipeline can be avoided, and data throughput can be increased.

Thus, in the present embodiment, a row of pixel data (e.g., row 0) including sideband information 420 is delivered to the deserializer 510 each clock cycle. In the example of FIG. 5, the deserializer deserializes the rows of pixel data. As described above, the pixel data for a group of pixels (e.g., a quad) may be interleaved row-by-row. Also, the pixel data arrives at the arithmetic logic stage row-by-row. Thus, deserialization, as referred to herein, is not performed bit-by-bit; instead, deserialization is performed row-by-row. If the graphics pipeline is four registers wide, and there are four rows per pixel, then the deserializer deserializes the pixel data into 16 registers per pixel.

In the example of FIG. 5, the deserializer sends the pixel data for a group of pixels to one of the buffers 0, 1 or 2. Pixel data is sent to one of the buffers while the pixel data in one of the other buffers is operated on by the ALUs, while the pixel data in the remaining buffer, having already been operated on by the ALUs, is serialized by the serializer 550 and fed, row-by-row, to the next stage of the graphics pipeline. Once a buffer is drained, it is ready to be filled (overwritten) with pixel data for the next group of pixels; once a buffer has been loaded, the pixel data it contains is ready to be operated on; and once the pixel data in a buffer has been operated on, it is ready to be drained (overwritten).

Pixel data including sideband information for a group of pixels (e.g., quad 0) arrives at the arithmetic logic stage, followed by pixel data including sideband information for the next group of pixels (e.g., quad 1), which is followed by the pixel data including sideband information for the next group of pixels (e.g., quad 2).

Once all of the rows of pixel data associated with a particular pixel have been deserialized, the pixel data for that pixel can be operated on by the ALUs. In one embodiment, the same instruction is applied to all pixels in a group (e.g., a quad). The ALUs are effectively a pipelined processor that operates in SIMD (same instruction, multiple data) fashion across a group of pixels.

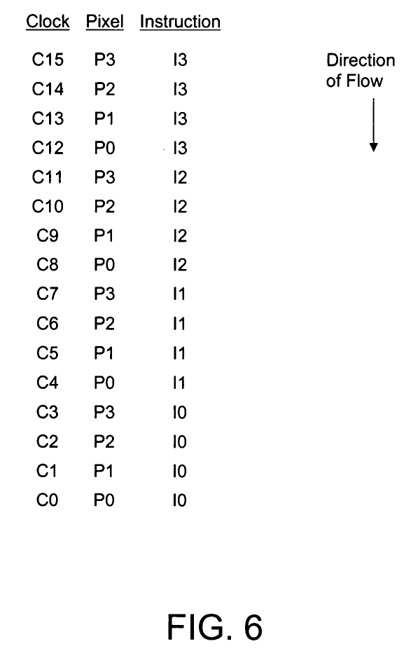

FIG. 6 shows pixel results exiting the ALUs over arbitrarily chosen clock cycles 0-15. In clock cycles 0-3, pixel results associated with execution of a first instruction I0, using pixel data for the pixels P0-P3, exit the ALUs. Similarly, pixel results associated with execution of a second instruction I1, using pixel data for the pixels P0-P3, exit the ALUs; and so on. With reference back to FIG. 4, instruction I0 is associated with row 0 of the pixel data for pixels P0-P3, instruction I1 is associated with row 1 of the pixel data for pixels P0-P3, and so forth. Because the same instruction is applied across pixels P0-P3, the ALUs operate in SIMD fashion.

FIG. 7A shows pixel data flowing through the stages of an ALU according to one embodiment of the present invention. In the present embodiment, it takes four clock cycles for an operand of pixel data to be operated on—more specifically, for an instruction to be executed. In essence, each ALU is four pipe stages deep. With reference also to FIG. 7B, during the first clock cycle, pixel data for a first pixel is read into the ALU (stage 1 of the ALU). During the second and third clock cycles, computations are performed on the pixel data—for example, in the second clock cycle, operands may be multiplied in a multiplier, and in the third clock cycle, multiplier results may be added in an adder (stages 2 and 3 of the ALU). During the fourth clock cycle (stage 4 of the ALU), pixel data is written back to a buffer or to a global register. Also during the second clock cycle, pixel data for a second pixel is read into the ALU—that data follows the row of pixel data for the first pixel through the remaining stages of the ALUs. Also during third clock cycle, pixel data for a third pixel is read into the ALU—that data follows the pixel data for the second pixel through the remaining stages of the ALUs. Once the ALU is “primed,” pixel data for one pixel follows pixel data for another pixel through the ALU as just described.

As noted above, in one embodiment, the same instruction originating from the per-row sideband information is applied to all pixels in a group (e.g., a quad). For example, at a given clock cycle, an instruction will specify a set of operands that are selected from the pixel data for a first pixel in the group of pixels. In the next clock cycle, the instruction will specify another set of operands that are selected from the pixel data for a second pixel in the group, and so on. According to embodiments of the present invention, a conditional execute bit originating from the per-row sideband information is associated with each set of operands. In general, if a conditional execute bit is set to do not execute, then the operands associated with that conditional execute bit are not operated on by the ALUs.

FIG. 7A shows the set of operands in each stage of an ALU according to one embodiment of the present invention. For example, with reference also to FIG. 7B, at clock cycle N−1, the set of operands in stage 1 of the ALU includes pixel data for pixel P1, as specified by instruction I2 (designated P1.I2 in the figure); stage 2 is operating on the set of operands selected from pixel data for pixel 0, but specified according to instruction I2 (P0.I2); and so on. In the next consecutive clock cycle N, each set of operands moves to the next ALU stage; the next set of operands to be loaded into the ALU is P2.I2.

In the example of FIG. 7A, the conditional execute bit associated with the operands P2.I2 is set to “do not execute.” The conditional execute bit may be set by the shader program at the top (front end) of the graphics pipeline. Alternatively, the conditional execute bit may be set (or reset) as a result of a previously executed instruction.

Accordingly, the operands P2.I2 are not operated on by the ALU. More specifically, in one embodiment, the operands P2.I2 are not latched by the ALU if the conditional execute bit is set to do not execute. As a result, the pipe stages of the ALU that would have operated on these operands do not change state. Thus, at clock cycle N, both stage 1 and stage 2 of the ALU contain the same data (P1.I2), because the flip-flops are not latched and therefore remain in the state they were in on the previous clock cycle N−1. Accordingly, the combinational logic in the downstream pipe stages of the ALU does not transition and power is not unnecessarily expended.

In clock cycle N+1, the combinational logic in stage 2 of the ALU is not switched because the operands are the same as that in the preceding clock cycle. Similarly, in clock cycle N+2, the combinational logic in stage 3 of the ALU is not switched. In clock cycle N+3, the flip-flops associated with stage 4 do not change state because the set of operands is the same as in the preceding clock cycle.

Even though the conditional execute bit is set to do not execute for the operands P2.I2, a set of “non-useful” operands effectively propagates through the ALU in its place. In this manner, the order of data through the graphics pipeline is maintained, and the timing across ALUs is also maintained.

Generally speaking, when the conditional execute bit is set to do not execute, the ALU does not perform any work on the pixel data associated with the conditional execute bit. In effect, the conditional execute bit acts as an enabling bit—if the bit is set to do not execute, then data flip-flops are not enabled and will not capture the new input operands. Instead, the outputs of the flip-flops retain their current state (the state introduced when data was captured in the preceding clock cycle). In one embodiment, this is achieved by gating the clocks of the flip-flops. If the conditional execute bit is set to do not execute, then the flip-flops that capture the input operands are not clocked—the clock signals do not transition, and so new data is not captured by the flip-flops. In one embodiment, only the flip-flops (e.g., latch 710 of FIG. 7B) in the first stage of the ALU are not clocked if the conditional execute bit is set to do not execute; however, the present invention is not so limited. That is, the clocks may be gated at one or more stages of the ALUs. Alternatively, instead of gating the clocks, the data inputs to the flip-flops can be gated under control of the conditional execute bit.

Power is saved by not clocking the flip-flops in the ALUs when not necessary. Power is also saved in the combinational logic of the ALUs because no switching activity occurs in the logic, because the operands are the same from clock to clock.

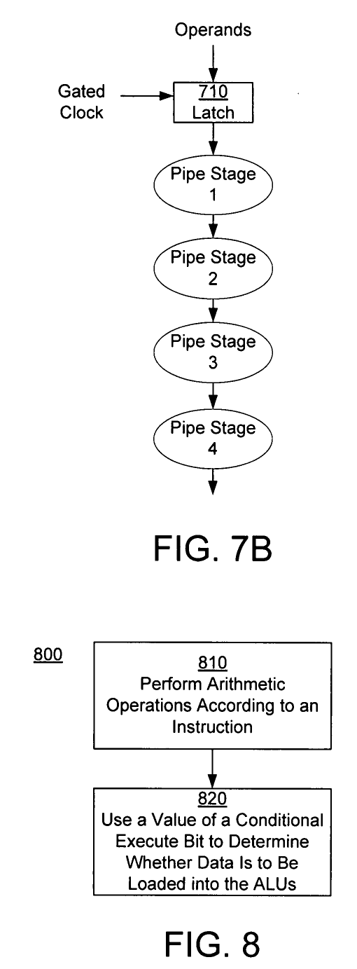

FIG. 8 is a flowchart 800 of an example of a computer-implemented method for processing pixel data in a graphics processor unit pipeline according to one embodiment of the present invention. Although specific steps are disclosed in the flowchart, such steps are exemplary. That is, embodiments of the present invention are well-suited to performing various other steps or variations of the steps recited in the flowchart. The steps in the flowchart may be performed in an order different than presented.

In block 810, arithmetic operations are performed according to an instruction. The same instruction is applied to different sets of operands of pixel data. Each set of operands is associated with a respective pixel in a group (e.g., quad) of pixels. A conditional execute bit is also associated with each set of operands.

In block 820, the value of the conditional execute bit associated with a set of operands is used to determine whether those operands are to be loaded into the ALUs. More specifically, the operands are loaded into and operated on by the ALUs if the conditional execute bit is set to a first value (e.g., 0 or 1) but not loaded into or operated on by the ALUs if the conditional execute bit is set to a second value (e.g., 1 or 0, respectively).

In summary, an instruction is applied across a group of pixels, but it may not be necessary to execute the instruction on pixel data for each pixel in the group. To maintain proper order in the pipeline, the instruction is applied to each pixel in the group—a set of operands is selected from the pixel data for each pixel in the group. However, if a conditional execute bit associated with a set of operands for a pixel is set to do not execute, then those operands for that pixel are not operated on by the ALUs. Consequently, ALU flip-flops are not unnecessarily clocked and switched, thereby saving power. As such, embodiments of the present invention are well-suited for graphics processing in handheld and other portable, battery-operated devices, as well as in other types of devices.

The foregoing descriptions of specific embodiments of the present invention have been presented for purposes of illustration and description. They are not intended to be exhaustive or to limit the invention to the precise forms disclosed, and many modifications and variations are possible in light of the above teaching. For example, embodiments of the present invention can be implemented on GPUs that are different in form or function from the GPU 110 of FIG. 2. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. A graphics processor unit (GPU) pipeline comprising:
a plurality of arithmetic logic units (ALUs) operable for performing arithmetic operations according to an instruction, wherein the instruction is applied to a plurality of sets of operands comprising pixel data, each set of operands in the plurality of sets of operands associated with a respective pixel of a plurality of pixels and a respective conditional execute bit, and wherein a value of a conditional execute bit associated with a first set of operands in the plurality of sets of operands determines how the pixel data in the first set of operands is processed by the ALUs.

2. The GPU pipeline of claim 1 wherein the first set of operands is operated on by the ALUs if the conditional execute bit associated with the first set of operands is set to a first value but not operated on by the ALUs if the conditional execute bit is set to a second value.

3. The GPU pipeline of claim 1 wherein the plurality of pixels comprises a pixel comprising a plurality of subsets of pixel data for the pixel, wherein a first conditional execute bit associated with one subset of pixel data for the pixel, and a second conditional execute bit associated with another subset of pixel data for the pixel, have different values.

4. The GPU pipeline of claim 1 wherein the ALUs comprise a plurality of stages comprising a plurality of latches, wherein the value of the conditional execute bit determines whether the first set of operands is latched by the ALUs.

5. The GPU pipeline of claim 4 wherein the latches comprise gated clocks, wherein the gated clocks are enabled and disabled under control of the conditional execute bit.

6. The GPU pipeline of claim 1 wherein the conditional execute bit is set according to a result of an operation on a second set of operands that preceded the first set of operands into the pipeline.

7. The GPU pipeline of claim 1 wherein the plurality of pixels comprises four pixels.

8. A graphics pipeline in a graphics processor unit, the pipeline comprising:
a data fetch stage; and
a plurality of arithmetic logic units (ALUs) coupled to the data fetch stage, wherein in successive clock cycles a first instruction identifies first operands for the ALUs and second operands for the ALUs, wherein the first operands are associated with a first pixel and a first conditional execute bit and the second operands are associated with a second pixel and a second conditional execute bit, wherein a value of the first conditional execute bit determines whether the first operands are operated on by the ALUs, and wherein a value of the second conditional execute bit determines whether the second operands are operated on by the ALUs.

9. The graphics pipeline of claim 8 wherein the first pixel comprises a plurality of subsets of pixel data for the first pixel, wherein a conditional execute bit associated with one subset of pixel data for the first pixel, and a conditional execute bit associated with another subset of pixel data for the first pixel, have different values.

10. The graphics pipeline of claim 9 wherein the plurality of subsets for the first pixel comprises up to four subsets of pixel data.

11. The graphics pipeline of claim 8 wherein the ALUs comprise a plurality of flip-flops, wherein the value of the first conditional execute bit determines whether the first operands are latched by the ALUs and wherein the value of the second conditional execute bit determines whether the second operands are latched by the ALUs.

12. The graphics pipeline of claim 11 wherein the flip-flops comprise gated clocks, wherein the gated clocks are controlled by the first and second conditional execute bits in turn.

13. The graphics pipeline of claim 8 wherein the value of the first conditional execute bit is set according to a result of an operation performed according to a second instruction that preceded the first instruction in time.

14. The graphics pipeline of claim 8 wherein the first and second pixels are members of a quad of pixels that proceed collectively through the graphics pipeline.

15. A computer-implemented method of processing data in a graphics processor unit pipeline, the method comprising:
performing arithmetic operations in an arithmetic logic unit (ALU) according to an instruction, wherein the instruction is applied to a plurality of sets of operands of pixel data, each set of operands in the plurality of sets of operands associated with a respective pixel of a plurality of pixels and a respective conditional execute bit; and
using a value of a conditional execute bit associated with a first set of operands, determining whether the pixel data in the first set of operands is to be loaded into the ALU.

16. The method of claim 15 further comprising operating on the first set of operands if the conditional execute bit associated with the first set of operands is set to a first value, wherein the first set of operands is not loaded into the ALU if the conditional execute bit is set to a second value.

17. The method of claim 15 wherein the plurality of pixels comprises a pixel comprising a plurality of subsets of pixel data for the pixel, wherein a first conditional execute bit associated with one subset of pixel data for the pixel, and a second conditional execute bit associated with another subset of pixel data for the pixel, have different values.

18. The method of claim 15 further comprising determining whether to latch the first set of operands based on the value of the conditional execute bit.

19. The method of claim 15 wherein the method further comprises controlling a gated clock in the ALU using the conditional execute bit.

20. The method of claim 15 further comprising setting the conditional execute bit according to a result of an operation on a second set of operands that preceded the first set of operands into the pipeline.

21. In a graphics processor unit, an arithmetic logic unit (ALU) pipe stage comprising:
a memory for storing a plurality of operands associated with a plurality of pixels;
a pipelined ALU coupled to the memory and comprising a plurality of pipe stages for executing an instruction on operands of each of the plurality of pixels, wherein operands associated with the plurality of pixels enter the ALU by one pixel on each clock cycle, wherein each set of operands is associated with a respective pixel of a plurality of pixels and wherein the memory is also for storing a respective flag bit for each pixel of the plurality of pixels; and
gating logic coupled to the ALU and for preventing operands associated with a first pixel of the plurality of pixels from entering the ALU on a first clock cycle provided the first pixel has an associated flag bit set.

22. The ALU pipe stage of claim 21 wherein the flag bit prevents the operands associated with the first pixel from being processed by the plurality of pipe stages of the ALU.

23. The ALU pipe stage of claim 22 wherein further, upon the flag bit being set, instead of the operands associated with the first pixel entering a first pipe stage of the ALU, the first pipe stage retains values of operands associated with a second pixel that entered the first pipe stage on a clock cycle just prior to the first clock cycle.
